(19) United States
(12) Patent Application Publication
(10) Pub. No.: US 2017/0353241 A1
(43) Pub. Date: Dec. 7, 2017

(54) Image-Processing System to Improve Modal Purity and Reduce Modal Crosstalk

(71) Applicants: Irfan Muhammad FAZAL, Ottawa (CA); Mohammad Mehdi MANSOURI RAD, Kanata (CA)

(72) Inventors: Irfan Muhammad FAZAL, Ottawa (CA); Mohammad Mehdi MANSOURI RAD, Kanata (CA)

(21) Appl. No.: 15/171,175

(22) Filed: Jun. 2, 2016

(51) Int. Cl. H04B 10/25

(52) U.S. Cl. CPC H04B 10/2504

(57) ABSTRACT

An optical system for coupling an optical signal into an orbital angular momentum (OAM) mode of an OAM optical fiber is disclosed. The system includes a first detector array for capturing an input image, a processor for processing the input image to determine modal purity and for generating a feedback signal based on the modal purity and a spatial light modulator (SLM) having an array of pixels that are adjustable in response to the feedback signal. This system improves modal purity and lessens modal crosstalk.

### TECHNICAL FIELD

The present disclosure relates generally to optical telecommunications and, more particularly, to space-division multiplexing using orbital angular momentum modes in few mode fibers.

### BACKGROUND

Space-division multiplexing using orbital angular momentum (OAM) modes in few mode fibers (FMF) has been identified as a viable solution to fulfill the demand for higher capacity in fiber transmission links. Each OAM mode can carry full C-band wavelength division multiplexed (WDM) signals. However, coupling of OAM modes into an FMF is highly sensitive to mechanical vibrations and environmental effects such as temperature variations. When the OAM mode is not optimally aligned into a fiber, crosstalk among the spatial modes may be induced, thus degrading performance. An active feedback technique may be implemented to compensate for offset and angle-of-incidence errors. Active feedback techniques, however, require monitoring of coupling efficiency. It is therefore highly desirable to provide an improved technique for monitoring coupling efficiency.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

The present specification discloses, in general, a technique for improving modal purity and lessening modal crosstalk for an OAM-based optical system such as, for example, an optical communication system. The optical system includes a spatial light modulator (SLM) for generating angular orbital momentum (OAM) modes. A modal purity of each of the OAM modes is assessed by capturing an optical interference image using a detector array disposed at an input of an OAM optical fiber, e.g. a few mode fiber (FMF). The captured image is compared (or correlated) with a reference interference image. The correlation can be quantified in terms of a figure of merit which is a numerical expression representing the coupling efficiency. If the coupling is well aligned, i.e. the coupling efficiency is high, the modes will be considered pure. Conversely, if the coupling is misaligned, i.e. the coupling efficiency is low, the modes will be considered impure. Measuring the modal purity is thus an indication of coupling efficiency. The processor generates a feedback signal that is communicated to the SLM to change its pixels in order to adjust the spatial modulation of the light. This active feedback to the SLM, based on image-correlation, enables the SLM to improve the modal purity of the OAM modes. Improving the modal purity of the OAM modes has the effect of reducing modal crosstalk over the FMF. Optionally, the optical system may include a second detector array at the output of the FMF to capture a second image representing the OAM modes at the output of the FMF. Correlation of the second image to a reference image, in the same manner as described above, characterizes the fiber effect of the FMF on the modal purity and modal crosstalk. The processor may thus, in one instance, generate the feedback signal based on both the figure of merit at the input of the FMF and the figure of merit at the output of the FMF. Image-correlation thus enables active feedback to the SLM in order to improve and/or control the modal purity of the OAM modes.

One aspect of the disclosure is an optical system for coupling an optical signal into an orbital angular momentum (OAM) mode of an OAM optical fiber. The system includes a first detector array for capturing an input image generated based on at least a portion of the optical signal, a processor for processing the input image to determine modal purity of the optical signal and for generating a feedback signal based on the modal purity and a spatial light modulator (SLM) having an array of pixels that are adjustable in response to the feedback signal for adjusting an optical phase profile of the optical signal before coupling the optical signal into the OAM optical fiber.

In some implementations, the system further includes a reference light source for providing a reference light beam for obtaining the input image by causing an optical interference of the reference light beam with the optical signal.

In some implementations, the processor is configured to compare the input image captured by the first detector array to a reference image representing a reference interference pattern. The reference interference pattern is generated from an analytic equation. In some instances, the processor may perform a fringe-pattern analysis.

In some implementations, the first detector array is disposed at an input of the OAM optical fiber for providing the input image to the processor.

In some implementations, a second detector array is disposed at an output of the OAM optical fiber for providing an output image to the processor, wherein the processor is configured for processing the output image to determine modal purity of the optical signal at the output of the OAM optical fiber. In some instances, the feedback signal is based on the modal purity of the input image and the modal purity of the output image.

Another aspect of the disclosure is a method of coupling an optical signal into an orbital angular momentum (OAM) mode of an OAM optical fiber. The method entails capturing an input image generated based on at least a portion of the optical signal using a first detector array, processing the input image, using a processor, to determine modal purity of the optical signal and to generate a feedback signal based on the modal purity, and adjusting pixels of a spatial light modulator (SLM) in response to the feedback signal for adjusting an optical phase profile of the optical signal before coupling the optical signal into the OAM optical fiber.

In some implementations, processing involves comparing the input image captured by the first detector array to a reference image representing a reference interference pattern. The processing may also involve performing a fringe-pattern analysis. Capturing of the input image may involve interfering a Gaussian reference beam with an optical signal.

In some implementations, the capturing of the image using the first detector array is performed by disposing the first detector array at an input of the OAM optical fiber for providing the input image to the processor.

In some implementations, the further involves capturing an output image using a second detector array disposed at an output of the OAM optical fiber for providing the output image to the processor. In some instances, the feedback signal is based on the modal purity of the input image and the modal purity of the output image.

Another aspect of the disclosure is an optical transmitting device for transmitting a space-division multiplexed signal using orbital angular momentum modes. The optical transmitting device includes at least one optical transmitter for transmitting an optical signal, a spatial light modulator (SLM) for modulating the optical signal to provide a modulated signal, a beam splitter for tapping off a portion of the modulated signal, and a detector array for capturing an image representing the portion of the modulated signal, wherein the spatial light modulator (SLM) is adjustable in response to a feedback signal generated based on a modal purity of the image.

The optical transmitting device may include a processor configured for processing the image to determine the modal purity and for generating the feedback signal based on the modal purity. The processor may be configured to compare the image captured by the detector array to a reference image representing a reference interference pattern of the modulated signal with a Gaussian reference beam. In some implementations, the processor also receives an additional feedback signal from an additional detector array disposed at an output of the OAM optical fiber.

### BRIEF DESCRIPTION OF THE DRAWINGS

These and other features of the disclosure will become more apparent from the description in which reference is made to the following appended drawings.

FIG. 1 depicts a system for assessing modal purity at an FMF input.

FIG. 2A depicts, by way of example, captured images of an OAM beam having OAM+3 and OAM−3 modes after interfering with a Gaussian beam.

FIG. 2B depicts the theoretical (reference) interference images for the OAM+3 and OAM−3 modes of FIG. 2A.

FIG. 3A depicts, by way of example, captured images of an OAM beam having OAM+5 and OAM−5 modes after interference with a Gaussian beam.

FIG. 3B depicts the theoretical (reference) interference images for the OAM+5 and OAM−5 modes of FIG. 3A.

FIG. 4 depicts a system for improving modal purity.

FIG. 5 depicts a system for assessing modal crosstalk at the FMF output.

FIG. 6 is a system for improving modal purity and reducing modal crosstalk by capturing images at both the input and output of the FMF.

FIG. 7 is a system for improving modal purity and reducing modal crosstalk by capturing images at only the input of the FMF.

FIG. 8 is a system for improving modal purity and reducing modal crosstalk by capturing images at only the output of the FMF.

FIG. 9 is a flowchart of a method of improving modal purity and reducing crosstalk by capturing images at only the input of the FMF.

FIG. 10 is a flowchart of a method of improving modal purity and reducing modal crosstalk by capturing images at both the input and output of the FMF.

FIG. 11 is a flowchart of a method of improving modal purity and reducing crosstalk by capturing images at only the output of the FMF.

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the designs and implementations illustrated and described herein, but may be modified within the scope of the appended claims along with their full scope of equivalents.

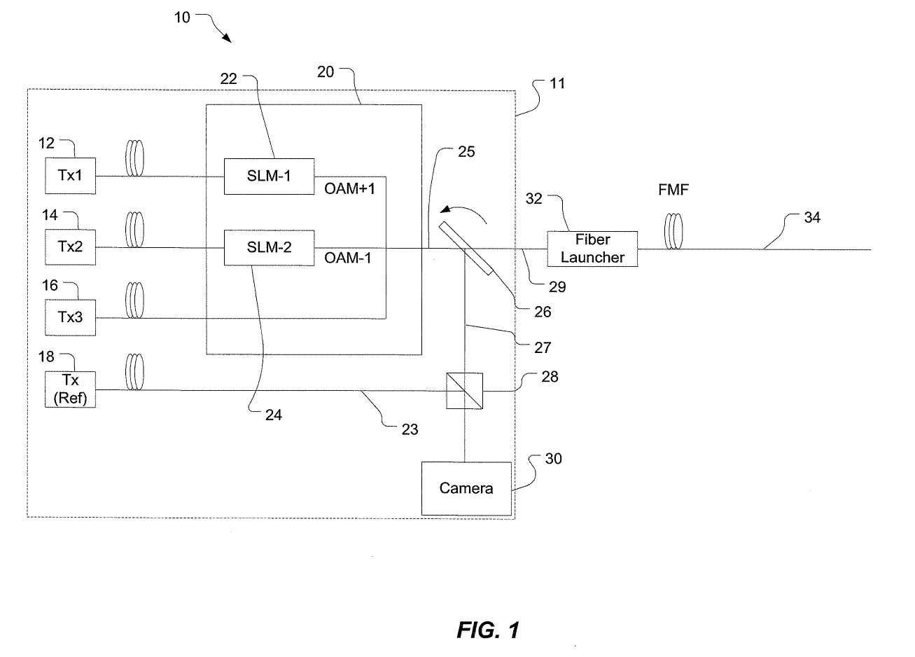

FIG. 1 depicts a portion of an optical system 10 such as, for example, an optical communication system, (hereinafter “the system”) having a first optical transmitter 12, a second optical transmitter 14, and a third optical transmitter 16. The system 10 also includes a reference beam transmitter 18 for transmitting a reference beam 23 (e.g. a Gaussian reference beam). The first, second, and third optical transmitters 12, 14, 16 may be light-emitting diodes (LEDs), Fabry-Perot (FP) lasers, distributed feedback (DFB) lasers, vertical cavity surface-emitting lasers (VCSELs) or another equivalent light-emitting source. The reference beam transmitter 18 may likewise be any one of the aforementioned light sources.

As illustrated in FIG. 1, the system 10 includes a mode multiplexer 20 which includes a first spatial light modulator (SLM) 22, which is also denoted SLM-1, and a second spatial light modulator (SLM) 24, which is also denoted SLM-2. The first SLM 22 and the second SLM 24 may be liquid crystal light modulators that operate as variable phase masks. Specifically, the first and second SLMs 22, 24 may each be a Liquid Crystal on Silicon-Spatial Light Modulator (LCOS-SLM) which is a reflection-type spatial light modulator that controls the wavefront of the reflected light by phase-modulating the light. The first SLM 22 generates a first OAM mode (OAM+1) by spatially modulating the light from the first optical transmitter 12. The second SLM 24 generates a second OAM mode (OAM−1) by spatially modulating the light from the second optical transmitter 14. The designations OAM+1 and OAM−1 are used herein to signify that the OAM modes have opposite helical directions. As shown in FIG. 1, the light from the third optical transmitter 16 is not modulated spatially, i.e. this light remains, for example, a Gaussian beam. The mode multiplexer 20 multiplexes, using a space-division multiplexing (SDM) technique, the OAM+1 light, the OAM−1 light and the unmodulated light to form an SDM-OAM beam 25. A flip mirror 26 reflects a portion of the SDM-OAM beam 25 onto a reflected path 27 toward a having a two-dimensional detector array. A beam combiner 28 causes the reference beam 23 to interfere with a reflected SDM-OAM beam traveling on the reflected path 27 to produce an interference pattern, an image of which is captured by the detector array of the camera 30. The detector array may include a charge-coupled device (CCD) sensor, a complementary metal-oxide semiconductor (CMOS) sensor, or any equivalent image-capturing device that is sensitive to light in the wavelength range being used to transmit the SDM-OAM beam 25.

As further illustrated in FIG. 1, when the flip mirror 26 is rotated out of the path of the beam, the SDM-OAM beam 25 propagates over an unreflected path 29 to a fiber launcher 32. The fiber launcher 32 couples the output of the mode multiplexer 20 to a an optical OAM fiber, e.g. a few mode fiber (FMF) 34, to enable the SDM-OAM beam 25 to be transmitted through the FMF 34 to an optical receiver downstream of the FMF. The optical receiver will be described below and shown in subsequent figures. The fiber launcher 32 may be a three-axis or six-axis fiber launcher 32 for coupling the mode multiplexer 20 to the OAM optical fiber, e.g. the FMF 34. The three-axis or six-axis fiber launcher 32 provides three-axis or six-axis positional control for aligning the mode multiplexer 20 with the FMF 34. In one embodiment, the flip mirror 26 is replaced with a beam splitter, which directs a small portion (e.g. 5-10%) of the SDM-OAM beam 25 to propagate along the reflected path 27. A beam splitter may allow a real-time monitoring of the optical coupling efficiency, without having to interrupt the SDM-OAM beam 25 for the optical coupling optimization. It may be undesirable to interrupt the SDM-OAM beam 25, which may carry customer's traffic.

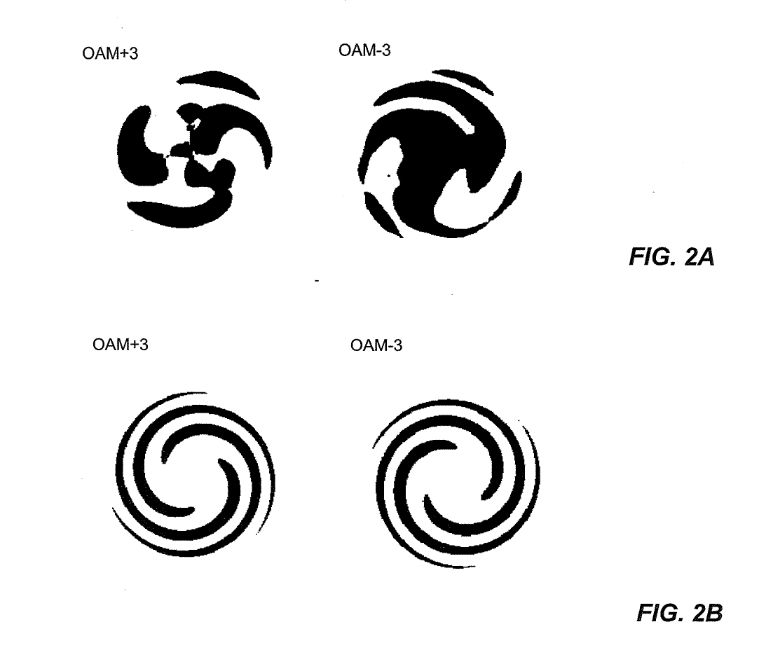

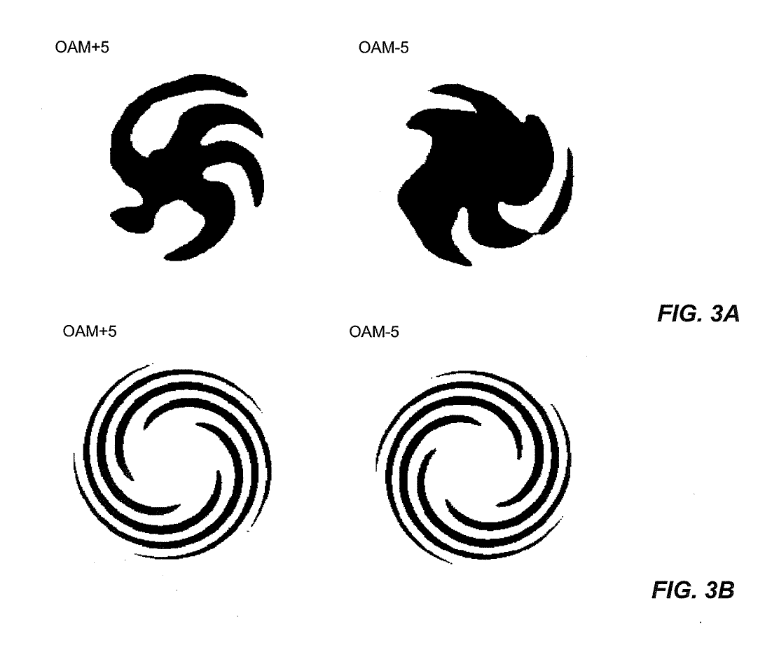

FIG. 2A depicts images captured by the camera 30 showing mode profiles of an OAM beam having OAM+3 and OAM−3 modes at an input of the fiber launcher 32. FIG. 2A depicts, by way of example, the captured images of the mode profiles after interference with the reference beam 23. The SDM-OAM beam has a spiraling or helical phase structure (also known as an optical vortex). In such an optical vortex, light spirals in a helical manner about its axis of propagation. The optical vortex is characterized by its topological charge, indicative of the number times the light orbits per wavelength. The topological charge (or “mode number”) is always an integer, which can be either positive or negative, depending on the direction (or helicity), i.e. right-handedness or left-handedness) of the spiral. In FIGS. 2A and 2B, the number of fringes indicates the mode number. The direction of the fringes (+/−) indicates the direction of the spiral. As shown in FIGS. 2A and 2B, there are three fringes, representing OAM+3 and OAM−3 (in which the plus and minus signs indicate the direction of helicity). In FIGS. 3A and 3B, there are five fringes for the OAM+5 and OAM−5 modes.

The images captured by the camera 30 or other detector array, such as those presented by way of example in FIGS. 2A and 3A, are compared (or correlated) with reference interference images (such as those shown respectively in FIGS. 2B and 3B) to determine how pure or impure the modes are. The reference interference images (e.g. the images shown in FIGS. 2B and 3B) may be generated using one or more equations such as, for example, the Laguerre-Gaussian (LG) mode set and the Laguerre polynomials which are disclosed in Yao, A. M. and Padgett, M. J. (2011) Orbital angular momentum: origins, behavior and applications. Advances in Optics and Photonics, 3 (2). P. 161. ISSN 1943-8206, which are hereby incorporated by reference. This comparison or correlation between the theoretical (reference) interference patterns (e.g. FIGS. 2B and 3B) and the captured images (FIGS. 2A and 3A) thus provides an assessment of modal purity. In other words, the captured images represent an efficiency of input beam coupling into respective OAM modes. Each image correlation provides a cost function for the purity of the input beam. The modal purity of the transmitted signal determines the level of crosstalk that will be experienced. Impure modes at the fiber input (i.e. the input of the FMF) will excite undesired modes, thereby increasing intermodal interference or crosstalk and reducing optical power levels in the targeted modes. Impure modes at the fiber output could also result from misalignment at the input. Quantifying the modal purity enables the first and second SLMs 22, 24 to be controlled or adjusted in order to improve the modal purity and reduce crosstalk of the transmitted optical signals. Each of the first and second SLMs 22, 24 may include adjustable (i.e. reprogrammable) pixels that operate as a phase mask or grating to control or improve the modal purity.

The degree of correlation between the captured image and a reference optical interference image may be expressed in terms of a figure of merit, which is a numerical expression representing the coupling efficiency of light into the OAM optical fiber, e.g. into the FMF 34. If the coupling is well aligned, i.e. the coupling efficiency is high, the modes can remain pure. Conversely, if the coupling is misaligned, i.e. the coupling efficiency is low, the modes will be impure. Measuring the modal purity is thus an indication of coupling efficiency.

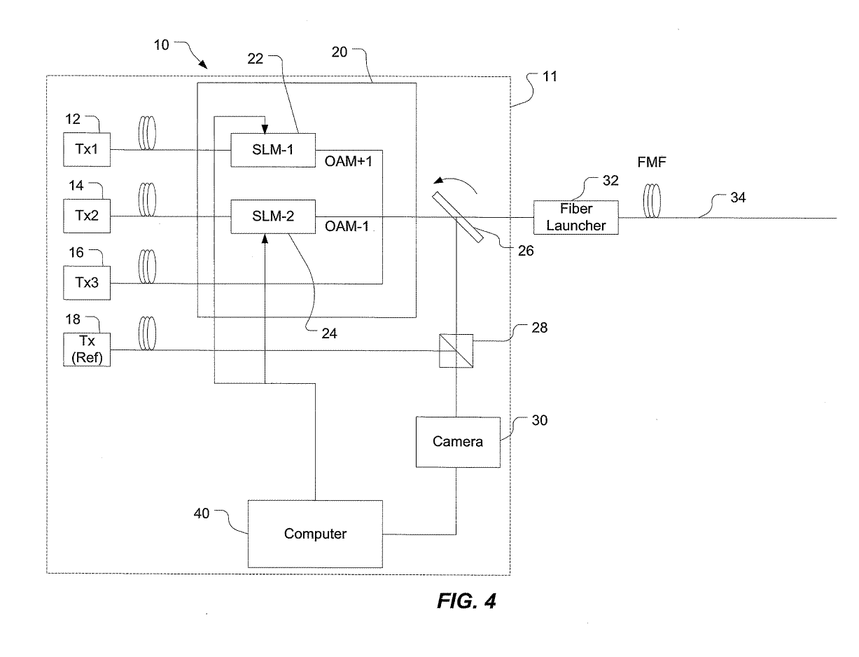

In one embodiment, the image comparison (or image correlation) described above is performed by a processor (e.g. a computer 40 having the processor) as shown by way of example in FIG. 4. The processor of the computer 40 may, for example, receive image data of a captured image from the camera 30 and perform a fringe-pattern analysis on the image data to compare the captured image with a reference optical interference image stored in a memory coupled to the processor of the computer 40. The fringe-pattern analysis may involve performing a Fourier-transform fringe-analysis method as disclosed by Takeda et al. in “Fourier-transform method fringe-pattern analysis for computer-based topography and interferometry” in J. Opt. Soc. Am, Vol. 72, No. 1, January 1982, which is hereby incorporated by reference. Instead of a fringe pattern analysis, the correlation may involve comparison of any other identifiable pattern, profile or signature. Alternatively, the processor may apply one of several digital signal processing techniques such as intensity profile mask associated with the targeted mode. Based on this correlation or other analysis, the processor of the computer 40 generates a figure of merit representing a degree of correlation between detected and ideal images that is therefore indicative of modal purity. The computer 40 may generate and transmit a first feedback signal to the first transmitter-side SLM 22 and a second feedback signal to the second transmitter-side SLM 24 to change (reprogram) their pixels in order to adjust the spatial modulation of the light. This active feedback to the first and second SLMs 22, 24, based on image correlation, enables the SLMs 22, 24 to improve the modal purity of the OAM modes. Improving the modal purity of the OAM modes has the effect of reducing modal crosstalk over the OAM optical fiber, e.g. the FMF 34. Although the system of FIG. 4 includes the flip mirror 26, an alternate system may include an inline tap to continually feed a portion of the optical signal to the detector array 30. This alternate system will be described below in greater detail.

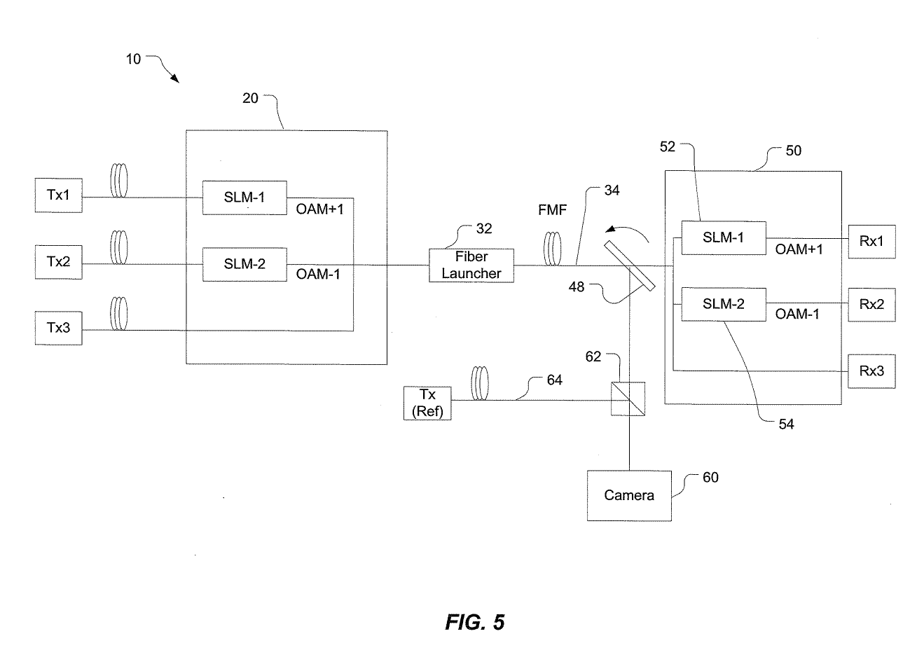

FIG. 5 illustrates an optical system 10 having a mode demultiplexer 50 downstream of the OAM optical fiber, e.g. FMF 34, for demultiplexing the SDM-OAM beam carried by the OAM optical fiber, e.g. FMF 34. The mode demultiplexer 50 includes a first receiver-side SLM 52 and a second receiver-side SLM 54 for outputting light at the OAM+1 and OAM−1 modes for the receivers Rx1 and Rx2. A receiver-side flip mirror or beam splitter 48 selectively reflects the received beam to a receiver-side beam combiner 62 which causes a receiver-side reference beam 64 to interfere with the reflected beam to form an interference pattern captured by the receiver-side detector array 60.

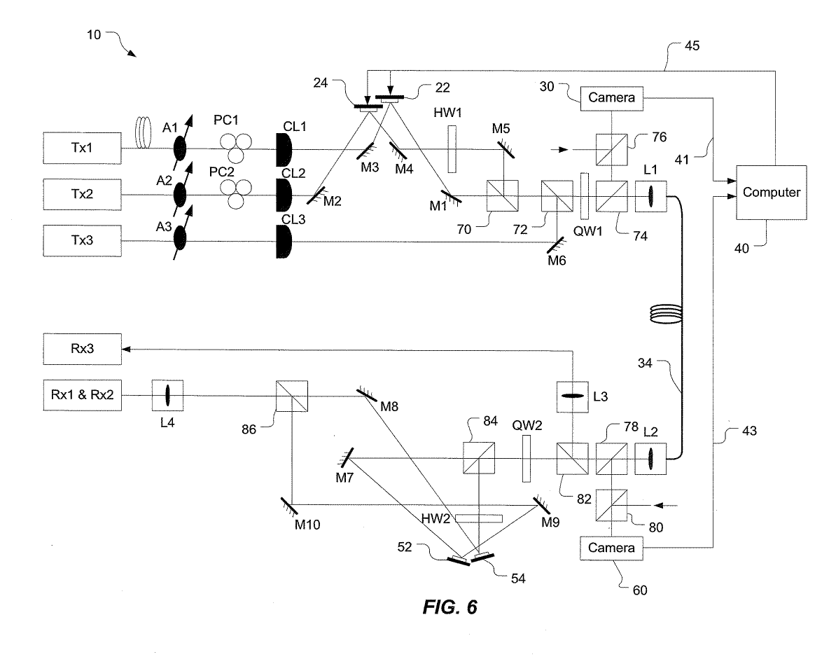

FIG. 6 illustrates an embodiment of the optical system 10 in which beam images are captured by both input-side and output-side detector arrays 30, 60. The computer 40 receives the images captured by the cameras 30, 60 and computes, using one or more processors, a figure of merit based on how closely the captured images resemble ideal interference patterns stored in a memory of the computer 40 or in a storage device that is accessible by the computer 40. The computer 40 generates a first feedback signal for the first SLM 22 to cause the first SLM 22 to vary its pixels to adjust the OAM modulation of the light from Tx1. The first SLM 22, the camera 30 and the computer 40 thus constitute an active feedback loop for continually monitoring and adjusting the modulation of the light from Tx1. Analogously, the second SLM 24 varies its pixels to adjust the OAM modulation of the light from Tx2 based on a second feedback signal from the computer 40. The first and second feedback signals may be transmitted as separate signals or combined as a single feedback signal. This active feedback thereby improves the modal purity of the OAM modes. This improved modal purity lessens the modal crosstalk. It will be understood that the active feedback will improve the modal purity until a practical threshold is reached, at which point, the active feedback will effectively maintain the modal purity at this level until there is a mechanical disturbance causing misalignment or drift, in which case the active feedback will seek to rectify the modal impurity due to the misalignment. Thus, for the purposes of this specification, the references to “improving modal purity” include maintaining the modal purity once the modal purity has attained its practical maximum.

In the embodiment depicted in FIG. 6, the optical system 10 includes two transmitter-side SLMs 22, 24 that spatially modulate the optical signals transmitted by Tx1 and Tx2, respectively. As shown, the optical system 10 includes attenuators A1, A2, A3, polarization controllers PC1, PC2 and collimating lenses CL1, CL2, CL3. In the embodiment shown in FIG. 6, a plurality of mirrors M1, M2, M3, M4, M5, a half-wave plate HW1, and a beam combiner 70 cooperate with the first and second SLMs 22, 24 to modulate and then combine the OAM modes. The beam from Tx3 is further combined by a beam combiner 72 before the combined beam passes through a quarter-wave plate QW1. A beam splitter 74 taps off a portion of the beam which then interferes with a Gaussian reference beam at a beam combiner 76 to form an interference pattern which is detected by the camera 30. The camera 30 captures images and provides image data of the captured images to the computer 40 for processing, i.e. correlation with ideal interference images. The camera 30 communicates the image data over an input-side image transmission link 41. The computer 40 provides the feedback signals to the first and second SLMs 22, 24 via one or more feedback signal communication link(s) 45. This link 41 may be a wireless link, a fiber optic link, etc.

As further shown in FIG. 6, the system 10 includes a lens L1 coupled to the OAM optical fiber, e.g. the FMF 34. The lens L1 may be part of, or separate from, the fiber launcher 32 described earlier. At the output (receiver side) of the OAM optical fiber, e.g. FMF 34, is another lens L2. A portion of the received beam is tapped off by a beam splitter 78 and interferes with a Gaussian reference beam at a beam combiner 80 to create an interference pattern. An image of this interference pattern is captured by the camera 60. The camera 60 communicates image data of the captured images to the computer 40 over an output-side image transmission link 43 to enable feedback control of first and second receiver-side SLMs 52, 54. As further depicted in FIG. 6, an untapped portion of the output beam is split by beam splitter 82 such that one fraction of the split light passes through lens L3 to receiver Rx3. The remaining fraction of the light passes through a quarter-wave plate QW2 and a beam splitter 84 where the light is further split into one component that is reflected by a mirror M7, is then demodulated by the second receiver-side SLM 54, and is subsequently reflected by mirrors M9 and M10 into a beam combiner 86. The other component from the beam splitter 84 passes through a half-wave plate HW2 and is demodulated by the first receiver-side SLM 52. From the first receiver-side SLM 52 the demodulated beam is reflected by mirror M8 into the beam combiner 86. The beam combiner 86 thus combines the two demodulated beams into a combined beam which passes through a lens L4 to receivers Rx1, Rx2.

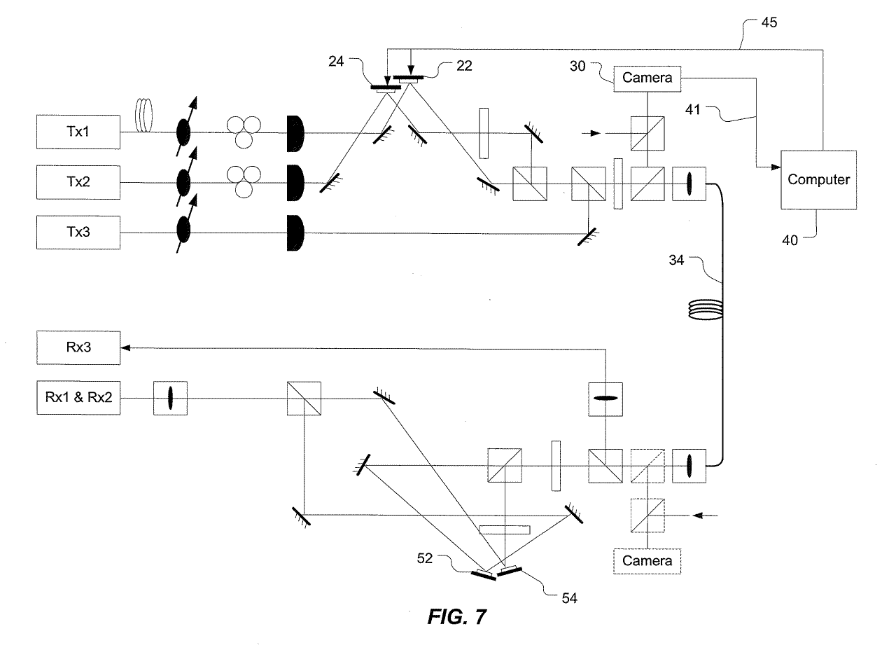

FIG. 7 shows another embodiment in which only the input-side camera 30 captures images for the computer 40. The input-side camera 30 communicates image data over the input-side image transmission link 41. The computer 40 generates the feedback signal based only on the images of the beam captured by the camera 30 that is disposed at the input of the OAM optical fiber, e.g. the FMF 34.

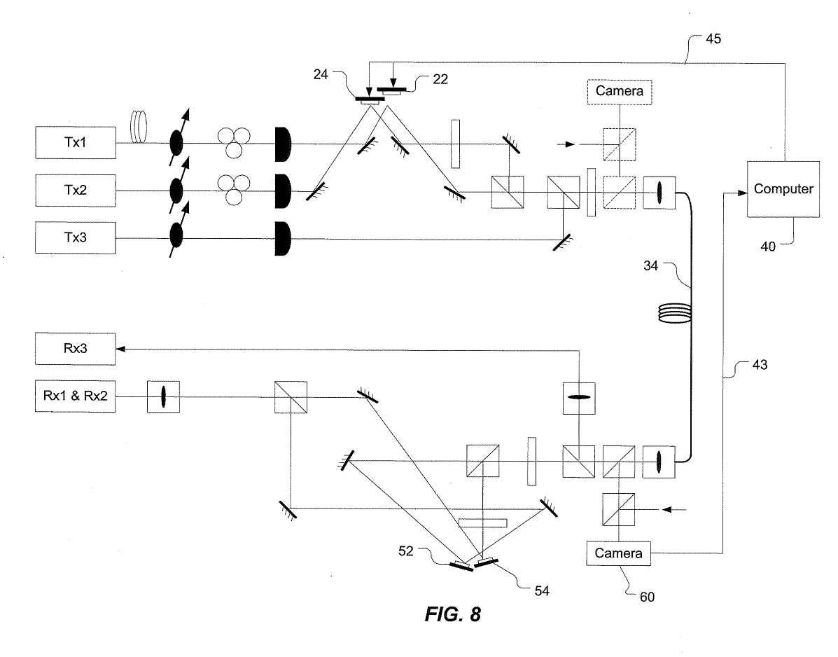

FIG. 8 shows another embodiment in which only the output-side camera 60 captures images for the computer 40. The output-side camera 60 communicates image data over the output-side image transmission link 43. The computer 40 generates the feedback signal based only on the images of the beam captured by the camera 60 that is disposed at the output of the OAM optical fiber, e.g. the FMF 34.

In FIGS. 6, 7 and 8, the feedback signal may be communicated to the SLM via the feedback signal communication link 45 which may be any suitable communication link such as, for example, a fiber-optic link, an RF or wireless link, etc.

Another aspect of this disclosure is an optical transmitting device 11 for transmitting a space-division multiplexed signal using orbital angular momentum modes. As shown in the embodiments presented in FIGS. 1 and 4, the optical transmitting device 11 includes one or more transmitters 12, 14, 16 (e.g. Tx1, Tx2, Tx3) for transmitting one or more optical signals and one or more transmitter-side spatial light modulators (SLM) 22, 24 for modulating the one or more optical signals to provide one or more OAM-modulated signals. The optical transmitting device 11 includes a beam splitter or flip mirror 26 for tapping off a portion of the modulated signal(s). The optical transmitting device 11 includes a detector array (e.g. the camera 30), or any other suitable image detector, for capturing images from which a modal purity can be determined. The images are generated by interference with a Gaussian reference beam from transmitter 18 prior to being captured by the camera 30. The interference produces a spiral-shaped mode in which the number of fringes of the spiral shape and the direction of rotation provide a distinct signature of the OAM mode. The images are provided to the computer 40 (shown in FIG. 4) which may be part of the optical transmitting device (as shown in FIG. 4) or which may be external to the optical transmitting device (as shown in FIG. 1). The computer 40 is configured to control the transmitter-side spatial light modulators (SLM) 22, 24 in response to the degree of correlation between the captured image and a reference interference image. The modal purity can thus be quantified by this correlation of the captured image with the ideal interference image. This enables the computer 40 to control the first and second transmitter-side SLMs 22, 24 by transmitting first and second feedback signals (or control signals) to the first and second transmitter-side SLMs 22, 24 to alter the pixels of the first and second transmitter-side SLMs 22, 24 to improve the modal purity. In other words, the first and second transmitter-side SLMs 22, 24 are each adjustable in response to feedback signals indicative of the modal purity of the captured images.

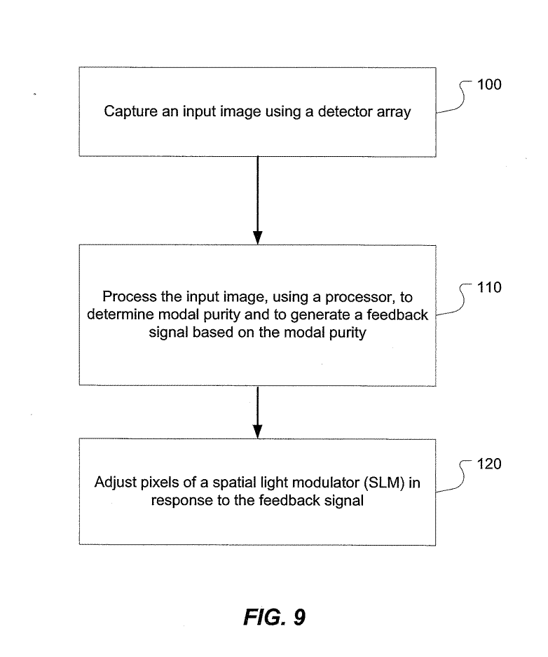

Another aspect of the disclosure is a method of optical communication using space-division multiplexing based on orbital angular momentum (OAM) modes. In general, as shown in FIG. 9, the method entails a step 100 of capturing an input image using a first detector array, e.g. a detector array of the camera 30, a step 110 of processing the input image, using a processor of the computer 40, to determine modal purity and to generate a feedback signal based on the modal purity, and a step 120 of adjusting pixels of a spatial light modulator (SLM) 22, 24 in response to the feedback signal. FIG. 9 thus presents a method of improving modal purity and reducing crosstalk by capturing images at only the input of the FMF.

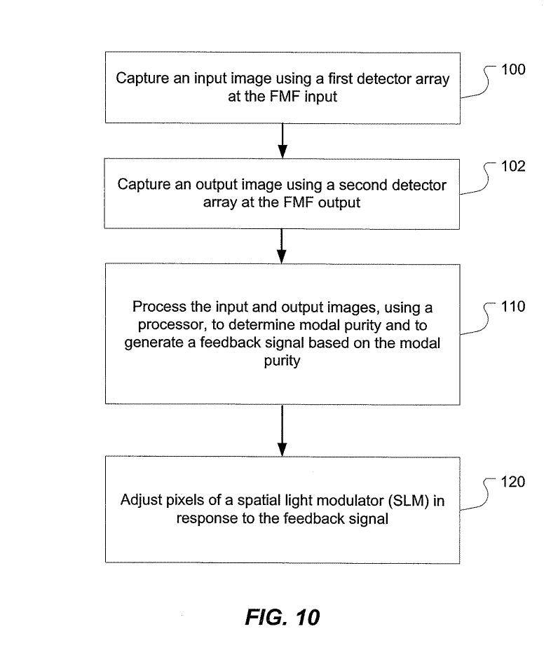

FIG. 10 is a flowchart of a method of improving modal purity and reducing modal crosstalk by capturing images at both the input and output of the FMF. As shown in FIG. 10, the method entails the step 100 of capturing an input image using a first detector array, e.g. a detector array of the camera 30, a step 102 of capturing an output image using a second detector array, e.g. a detector array of the camera 60, the step 110 of processing the input and output images, using a processor of the computer 40, to determine modal purity and to generate a feedback signal based on the modal purity, and a step 120 of adjusting pixels of a spatial light modulator (SLM) 22, 24 in response to the feedback signal.

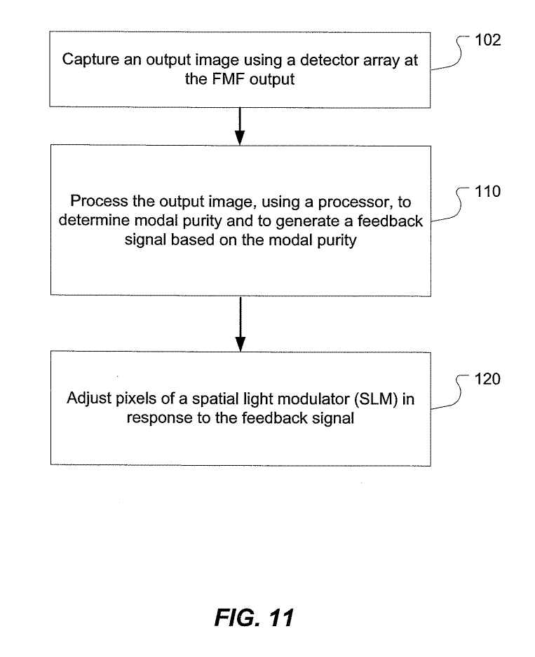

FIG. 11 is a flowchart of a method of improving modal purity and reducing crosstalk by capturing images at only the output of the FMF. As shown in FIG. 11, the method entails the step 102 of capturing an output image using the second detector array, e.g. a detector array of the camera 60, the step 110 of processing the output image, using a processor of the computer 40, to determine modal purity and to generate a feedback signal based on the modal purity, and a step 120 of adjusting pixels of a spatial light modulator (SLM) 22, 24 in response to the feedback signal.

These methods seek to improve the modal purity of the OAM modes to lessen the modal crosstalk at the FMF output that arise due to optical misalignment. As described above, image correlation of interference patterns enable the modal purity to be characterized by cost functions (e.g. a figure of merit) that are used by a feedback loop to improve coupling efficiency (i.e. improve modal purity and diminish crosstalk). These methods may be used inline without disturbing data traffic and may furthermore be performed using inexpensive components. The monitoring and correction of modal purity can thus be done flexibly at the input and/or output of the FMF.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including”, “entailing” and “containing”, or verb tense variants thereof, are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. An optical system for coupling an optical signal into an orbital angular momentum (OAM) mode of an OAM optical fiber, the system comprising:
a first detector array for capturing an input image generated based on at least a portion of the optical signal;
a processor for processing the input image to determine modal purity of the optical signal and for generating a feedback signal based on the modal purity; and
a spatial light modulator (SLM) having an array of pixels that are adjustable in response to the feedback signal, for adjusting an optical phase profile of the optical signal before coupling the optical signal into the OAM optical fiber.

2. The system of claim 1, further comprising a reference light source for providing a reference light beam for obtaining the input image by causing an optical interference of the reference light beam with the optical signal.

3. The system of claim 2 wherein the processor is configured to compare the input image captured by the first detector array to a reference image representing a reference optical interference pattern.

4. The system of claim 1 wherein the first detector array is disposed at an input of the OAM optical fiber, for providing the input image to the processor.

5. The system of claim 4 further comprising a second detector array disposed at an output of the OAM optical fiber for providing an output image to the processor, wherein the processor is configured for processing the output image to determine modal purity of the optical signal at the output of the OAM optical fiber.

6. The system of claim 5 wherein the feedback signal to the SLM is based on the modal purity of the input image and the modal purity of the output image.

7. The system of claim 2 wherein the reference light beam comprises a Gaussian beam.

8. The system of claim 5 wherein the first detector array and the second detector array are CCD detector arrays.

9. A method of coupling an optical signal into an orbital angular momentum (OAM) mode of an OAM optical fiber, the method comprising:
Capturing, using a first detector array, an input image generated based on at least a portion of the optical signal;
processing the input image, using a processor, to determine modal purity of the optical signal and to generate a feedback signal based on the modal purity; and
adjusting pixels of a spatial light modulator (SLM) in response to the feedback signal for adjusting an optical phase profile of the optical signal before coupling the optical signal into the OAM optical fiber.

10. The method of claim 9 further comprising providing a reference light beam for obtaining the input image by causing an optical interference of the reference light beam with the optical signal.

11. The method of claim 10 wherein the processing comprises comparing the input image captured by the first detector array to a reference image representing a reference optical interference pattern.

12. The method of claim 9 wherein the capturing of the image using the first detector array is performed by disposing the first detector array at an input of the OAM optical fiber for providing the input image to the processor.

13. The method of claim 12 further comprising capturing an output image using a second detector array disposed at an output of the OAM optical fiber for providing the output image to the processor.

14. The method of claim 13 further comprising providing the feedback signal to the SLM based on the modal purity of the input image and the modal purity of the output image.

15. The method of claim 14 wherein the capturing of the input image comprises interfering a Gaussian reference beam with the optical signal.

16. The method of claim 13 wherein capturing the input image and capturing the output image are performed using CCD detector arrays.

17. An optical transmitting device for transmitting a space-division multiplexed signal using orbital angular momentum modes, the optical transmitting device comprising:
at least one optical transmitter for transmitting an optical signal;
a spatial light modulator (SLM) for modulating the optical signal to provide a modulated signal;
a beam splitter for tapping off a portion of the modulated signal; and
a detector array for capturing an image representing the portion of the modulated signal, wherein the spatial light modulator (SLM) is adjustable in response to a feedback signal generated based on a modal purity of the modulated signal.

18. The optical transmitting device of claim 17 further comprising a processor for processing the image to determine the modal purity and for generating the feedback signal based on the modal purity.

19. The optical transmitting device of claim 18 wherein the processor is configured to compare the image captured by the detector array to a reference image representing a reference optical interference pattern of the modulated signal with a Gaussian reference beam.

20. The optical transmitting device of claim 19 wherein the processor is also configured to receive an additional feedback signal from an additional detector array disposed at an output of an OAM optical fiber.
